(19) United States
(12) Patent Application Publication
(10) Pub. No.: US 2004/0192110 A1
(43) Pub. Date: Sep. 30, 2004

(54) Electric connector

(76) Inventor: Wu Bin Yen, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/394,232

(22) Filed: Mar. 24, 2003

(51) Int. Cl. H01R 13/648

(52) U.S. Cl. 439/607

(57) ABSTRACT

An electric connector formed of a housing, a set of terminals and a metal shield is disclosed, in which the terminals each have a hooked portion forced into engagement with the inside wall of the corresponding terminal slot in the housing, and the housing has a hook hooked in a respective hook hole of the metal shield to secure the metal shield in position.

### BACKGROUND OF THE INVENTION

1. Field of the Invention

The present invention relates to electric connectors and, more particularly, to such an electric connector, which has the parts thereof positively fastened to one another and, which has grounding and metal shield means to protect against electromagnetic interference.

2. Description of the Related Art

A variety of electric connectors have been developed for use in computers, computer peripheral apparatus, PDAs (personal digital assistants), Cell phones, and any of a variety of mobile electronic apparatus. An electric connector for this purpose generally comprises an electrically insulative housing holding a set of terminals and a metal shield fastened to the outside of the housing for EMI protection. According to conventional designs, the metal shield may vibrate or be forced out of the housing accidentally after a long use of the electric connector.

### SUMMARY OF THE INVENTION

The present invention has been accomplished under the circumstances in view. It is one object of the present invention to provide an electric connector, which has the parts thereof positively fastened to one another against vibration. It is another object of the present invention to provide an electric connector, which has grounding and metal shield means to protect against electromagnetic interference.

According to the present invention, the electric connector comprises a housing, the housing having two parallel rows of terminal slots; a plurality of terminals respectively mounted in the terminal slots of the housing; and a metal shield mounted outside the housing for EMI (Electromagnetic interference) protection; wherein the terminals each have a hooked portion forced into engagement with an inside wall of the corresponding terminal slot in the housing; the housing comprises at least one hook adapted to secure the metal shield; the metal shield comprises at least one hook hole adapted to receive the at least one hook of the housing respectively.

### BRIEF DESCRIPTION OF THE DRAWINGS

FIGS. 1A-1C are elevational views of a housing for electric connector obtained from different angles according to the present invention.

FIGS. 1D-1F are elevational views of an alternate form of the housing for electric connector obtained from different angles according to the present invention.

FIG. 2 illustrates different terminals constructed according to the present invention.

FIG. 3 is an elevational view of a metal shield for the electric connector according to the present invention.

FIG. 4A is an elevational view of a grounding member for the electric connector according to the present invention.

FIG. 4B is an elevational view of an alternate form of the grounding member for the electric connector according to the present invention.

FIG. 5A is an elevational view of a rivet for the electric connector according to the present invention.

FIG. 5B is a longitudinal view in section of the rivet shown in FIG. 5A.

FIG. 6A is an elevational view of the electric connector according to the present invention (only one grounding member installed).

FIG. 6B is similar to FIG. 6A but showing a second grounding member installed.

FIG. 7 is an elevational view of a bolt for the electric connector according to the present invention.

FIG. 8 is an oblique top elevation of an electric connector according to the second embodiment of the present invention.

FIG. 9A is an elevational view of the housing for the electric connector according to the second embodiment of the present invention.

FIG. 9B is a rear side view of the housing for the electric connector according to the present invention.

FIG. 10 is an elevational view of the metal shield for the electric connector according to the second embodiment of the present invention.

### DETAILED DESCRIPTION OF THE PREFERRED EMBODIMENT

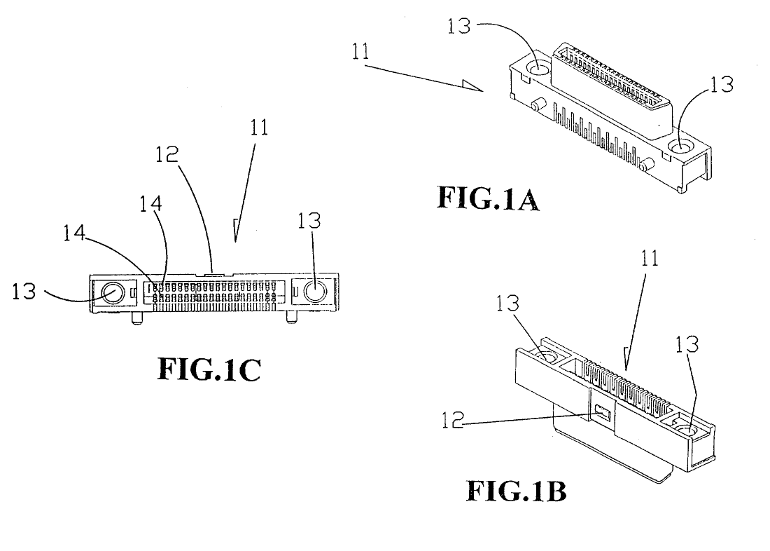

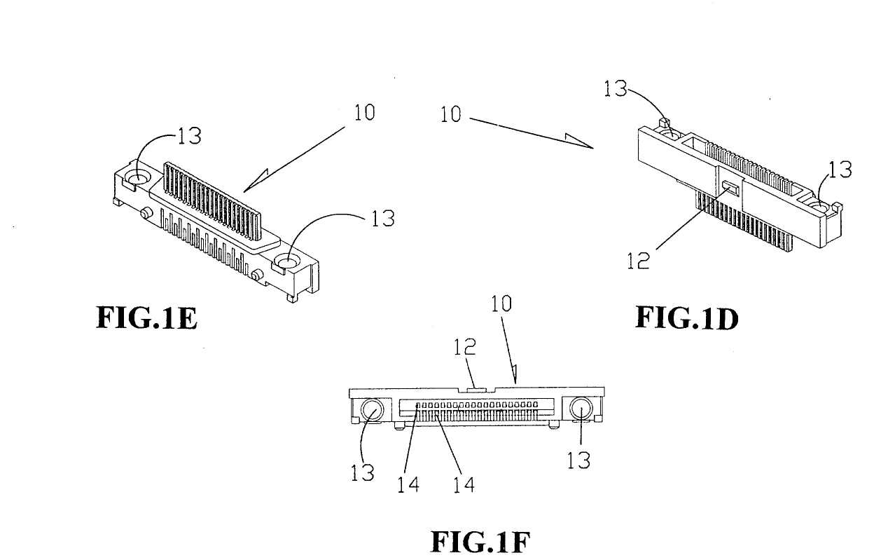

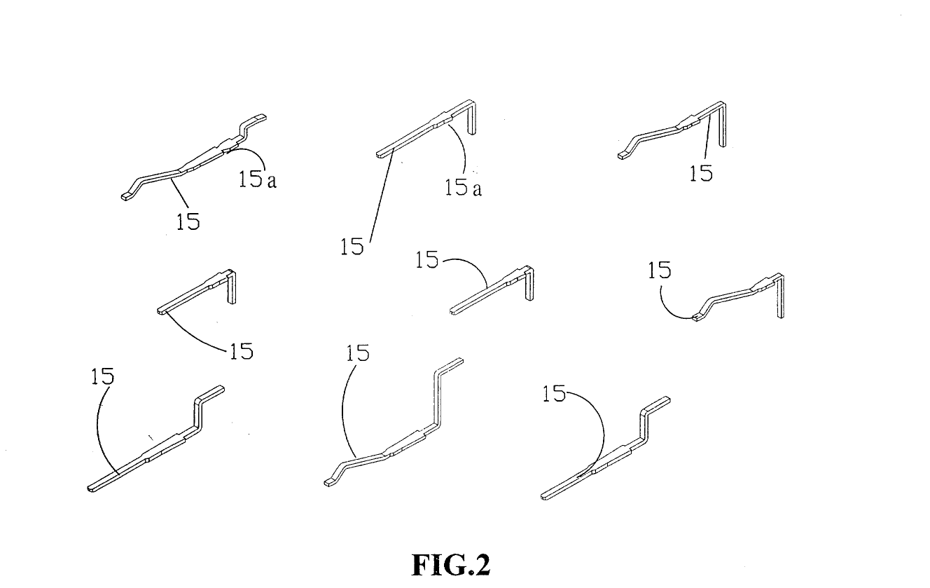

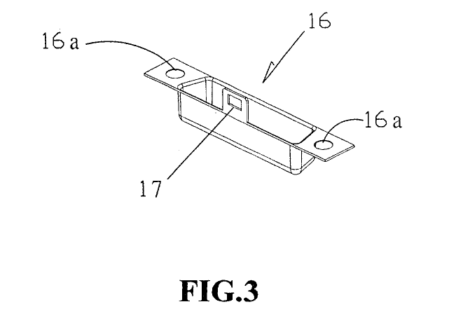

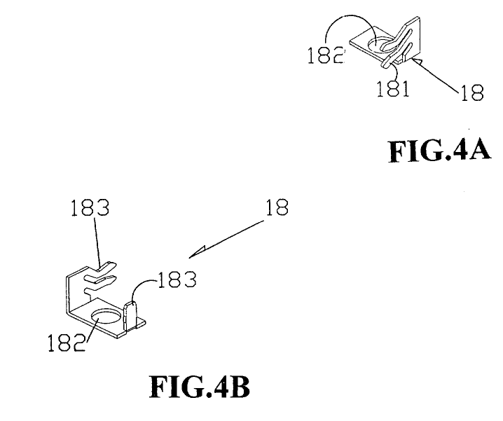

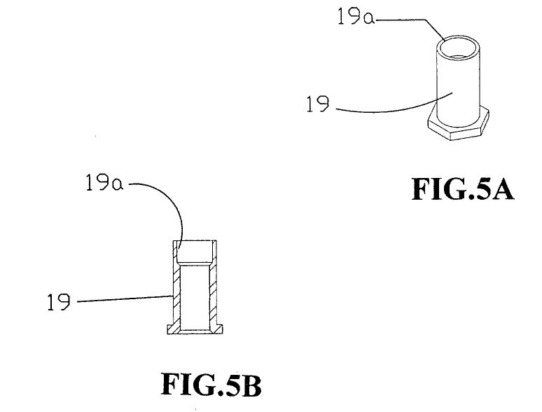

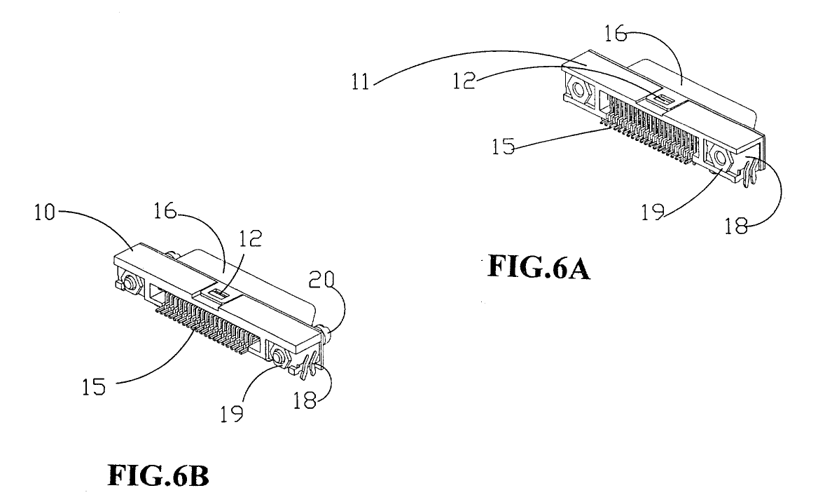

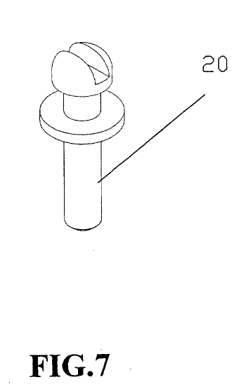

The housing 10 or 11 of an electric connector (FIGS. 1A-1F show different forms of electric connector constructed according to the present invention) comprises two parallel rows of terminal slots 14, a hook 12 at a front side, and two mounting holes 13 at two opposite lateral sides. Terminals 15 are respectively mounted in the terminal slots 14, each having a hooked portion 15a forced into engagement with the inside wall of the corresponding terminal slot 14 (FIG. 2 shows different forms of terminal adapted to fit the different forms of electric connector shown in FIGS. 1A-1F). A metal shield 16 (see FIG. 3) is provided for fastening to the aforesaid housing 10 or 11 for EMI (electromagnetic interference) protection, having a hook hole 17 for fastening to the hook 12 of the housing 10 or 11, and two mounting holes 16a for fastening to the mounting holes 13 of the housing 10 or 11 respectively. Two grounding members 18 are provided and respectively fastened to the housing 10 or 11 at two opposite lateral sides. The grounding member 18 can be made in the form of a substantially L-shaped profile having a mounting hole 182 and a mounting rod 181 (see FIG. 4A). Alternatively, the grounding member 18 can be made having a mounting hole 182 and two mounting rods 183 (see FIG. 4B). Two rivets 19 are respectively inserted through the mounting holes 16a of the metal shield 16, the mounting hole 182 of each of the grounding members 18 and the mounting holes 13 of the housing 10 or 11, and then the front plain end 19a of each rivet 19 is hammered down to fix the housing 10 or 11, the metal shield 16 and the grounding members 18 together (see FIGS. 5A, 5B, 6A, and 6B). The rivets 19 are internally threaded for receiving a respective screw bolt 20 (see FIG. 7).

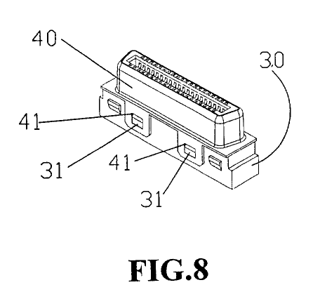

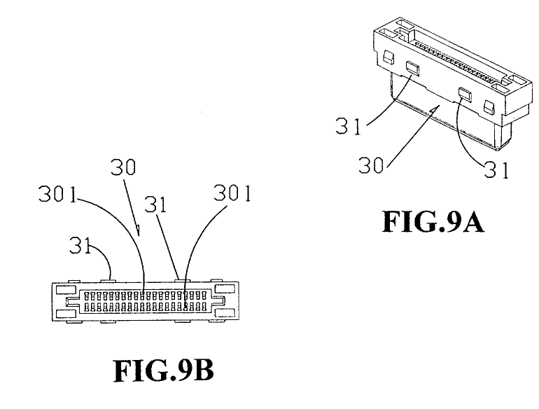

FIGS. 8 and 9 show a second embodiment of the present invention. According to this embodiment, the housing 30 comprises two parallel rows of terminal slots 301, which receive a respective terminal 15 (see also FIG. 2), and a plurality of hook holes 31, which receive respective hooks 41 of the metal shield 40.

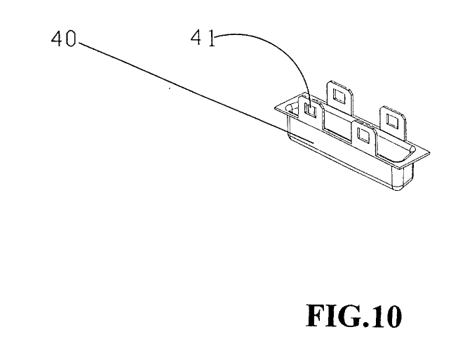

A prototype of electric connector has been constructed with the features of FIGS. 1-10. The electric connector functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An electric connector comprising:
a housing, said housing having two parallel rows of terminal slots;
a plurality of terminals respectively mounted in said terminal slots of said housing; and
a metal shield mounted outside said housing for EMI (Electromagnetic interference) protection;
wherein said terminals each have a hooked portion forced into engagement with an inside wall of the corresponding terminal slot in said housing; said housing comprises at least one hook adapted to secure said metal shield; said metal shield comprises at least one hook hole adapted to receive the at least one hook of said housing respectively.

2. The electric connector as claimed in claim 1, wherein said housing and said metal shield each have two mounting holes symmetrically disposed at two opposite lateral sides; two grounding members are respectively fastened to said housing and said metal shield for grounding, said grounding members each having a mounting hole respectively connected between one mounting hole of said housing and one mounting hole of said metal shield; two internally threaded rivets are respectively fastened to the mounting holes of said housing and said metal shield and the mounting hole of each of said grounding member to secure said housing and said metal shield and said grounding members together; two bolts are respectively threaded into said internally threaded rivets to hold down said internally treaded rivets in said housing.
